(19) United States
(12) Patent Application Publication
(10) Pub. No.: US 2026/0011963 A1
(43) Pub. Date: Jan. 8, 2026

(54) PLUG AND METHOD FOR MANUFACTURING PLUG

(71) Applicant: HOSIDEN CORPORATION, OSAKA (JP)

(72) Inventor: Takahide KAWANISHI, Osaka (JP)

(21) Appl. No.: 19/286,848

(22) Filed: Jul. 31, 2025

(30) Foreign Application Priority Data
Aug. 7, 2024 (JP) 2024-130907

(51) Int. Cl. H01R 24/54; H01R 43/20

(52) U.S. Cl. CPC H01R 24/54; H01R 43/20

(57) ABSTRACT

A plug includes a terminal member having a connecting section connected to an inner conductor of a coaxial cable, an insulating holder externally fitted to the terminal member, a conductive shell externally fitted to the holder, and a conductive grounding member disposed between the shell and the holder. The shell includes a cylindrical inner surface and a protrusion protruding from part of the cylindrical inner surface. The grounding member includes a pair of circular arc-shaped supports connected to the shell and a contact supported by the pair of supports. The pair of supports include a recess formed in a different place from where the contact is disposed. The grounding member is fixed to the shell by the protrusion fitting into the recess.

### CROSS REFERENCE TO RELATED APPLICATION

This application is based on and claims priority under 35 U.S.C. Section 119 to Japanese Patent Application No. 2024-130907 filed on Aug. 7, 2024, the entire content of which is incorporated herein by reference.

### TECHNICAL FIELD

This disclosure relates to a plug and a method for manufacturing the plug.

### RELATED ART

JP 59-65489UM-A discloses a plug (connector in JP 59-65489UM-A) that is electrically connectable to a coaxial cable. The plug has a central conductor that is electrically connectable to an inner conductor of the coaxial cable, a metal body that is disposed on the outer peripheral side of the central conductor and is to be electrically connected to the outer conductor of the coaxial cable, and an insulating dielectric supporting body disposed between the central conductor and the body. The body has a substantially cylindrical recess into which a socket (connector plug in JP 59-65489UM-A) for mating with the plug is inserted. Hereinafter, the direction parallel to the direction in which the socket is inserted will also be referred to as the axial direction.

On the inner peripheral surface of the recess in the body of the plug is disposed a grounding member (spring in JP 59-65489UM-A) made of a metal spring material. Both ends of the grounding member in the direction parallel to the axial direction serve as a pair of supports (annular sections in JP 59-65489UM-A), and between the pair of supports are disposed a plurality of (six in JP 59-65489UM-A) elastically deformable contacts (continuous sections in JP 59-65489UM-A) at predetermined intervals in the circumferential direction of the supports. In other words, the contacts extend in the axial direction. The grounding member is electrically connected to the body by the supports increasing in diameter due to elastic force and coming in contact with the inner peripheral surface of the recess.

The recess in the body of the plug has an annular opening on the side on which the grounding member is inserted, and the inner diameter of the opening is smaller than the inner diameter of the inner peripheral surface of other parts of the recess. That is, the opening protrudes radially inward of the inner peripheral surface of other parts of the recess, and there is a step between the opening and the other parts of the recess. The grounding member is disposed in such a manner that the other support comes in contact with the step and catches, thereby preventing the grounding member from coming out of the recess.

### SUMMARY

The recess in the body of the plug disclosed in JP 59-65489UM-A has an annular opening, and the grounding member is disposed on the inner side of the opening in the axial direction, and thus the length of the recess in the axial direction is shortened by the length of the opening in the axial direction. Because the length of the contacts of the grounding member disposed in the recess is also shortened for this reason, stress acting on the ends of the contacts increases even at the same amount of elastic deformation when compared to contacts that are long in length, and the limit of elasticity also decreases, leaving room for improvement.

In view of this, a plug and a manufacturing method for the plug that enable the length of the contacts to be increased and are capable of ensuring stable contact performance are desired.

One embodiment of the plug according to the present disclosure is a plug electrically connected to a coaxial cable, including a conductive terminal member having a cylindrical connecting section electrically connected to an inner conductor of the coaxial cable, an insulating holder externally fitted to the terminal member in such a manner as to be coaxial with an axis of the connecting section of the terminal member, a conductive shell electrically connected to an outer conductor of the coaxial cable and externally fitted to the holder in such a manner as to be coaxial with the axis, and a conductive grounding member disposed between the shell and the holder, the shell including a cylindrical inner surface on which the connecting section and the holder are disposed on an inner side coaxially with the axis, and a protrusion protruding radially inward from part of the cylindrical inner surface, the grounding member including a pair of circular arc-shaped supports electrically connected to the shell by coming in contact with the cylindrical inner surface, and an elastically deformable contact supported by the pair of supports, at least one of the two supports including a recess formed in a different place from where the contact is disposed, and the grounding member being fixed to the shell by the protrusion fitting into the recess.

According to the present embodiment, the shell has a cylindrical inner surface and a protrusion protruding radially inward from part of the cylindrical inner surface. Also, the grounding member has a pair of circular arc-shaped supports that are electrically connected to the shell by coming in contact with the cylindrical inner surface, and an elastically deformable contact supported by the pair of supports. Furthermore, at least one of the two supports of the grounding member includes a recess formed in a different place from where the contact is disposed. The grounding member is fixed to the shell by the protrusion fitting into the recess. Thus, the length of the contact can be increased, compared to when the contact is formed between the recesses and to the contacts of the plug disclosed in JP 59-65489UM-A. Stress that occurs at both ends of the contact (boundary with the supports) during elastic deformation thereby decreases and the limit of elasticity increases. In this way, a plug capable of ensuring stable contact performance over a long period of time can be realized.

In another embodiment of the plug according to the present disclosure, the protrusion is formed at an end into which a socket for mating with the plug is fitted, and the protrusion is longer than the recess in a direction along the axis.

According to the present embodiment, the protrusion is longer than the recess in the direction along the axis. Thus, with the grounding member brought in contact with the cylindrical inner surface of the shell and the protrusion fitted into the recess, the supports of the grounding member will not protrude from the shell.

In another embodiment of the plug according to the present disclosure, the plug further includes a housing externally fitted to the shell, and an annular packing disposed between the shell and the housing, the packing includes a large diameter section that comes in contact with both the shell and the housing, and a small diameter section that comes in contact with only the shell and has a gap to the housing, and the socket for mating with the plug is fitted in such a manner as to come in contact with the small diameter section in the gap.

According to the present embodiment, the gap between the plug and the socket is sealed, by the socket coming in contact with the outer peripheral surface of the small diameter section of the packing. Dust, water droplets, and the like can thereby be prevented from intruding inside the plug.

In another embodiment of the plug according to the present disclosure, the shell has a flange section that prevents the packing from coming off.

According to the present embodiment, the packing can be maintained in contact with the shell.

In another embodiment of the plug according to the present disclosure, the terminal member has a plate-shaped section integrally formed with the connecting section, the inner conductor of the coaxial cable includes a flat plate-shaped connecting portion to be electrically connected to the plate-shaped section, and the plate-shaped section is electrically connected to the connecting portion in surface contact therewith.

According to the present embodiment, the contact area between the plate-shaped section of the terminal member and the connecting portion of the coaxial cable increases. The welding area between the plate-shaped section and the connecting portion can thereby be increased when, for example, the plate-shaped section is electrically connected to the connecting portion by welding, and contact resistance between the plate-shaped section and the connecting portion can be reduced.

One embodiment of a method for manufacturing a plug according to the present disclosure is a method for manufacturing the plug described above, including a conductor forming step of forming the inner conductor of the coaxial cable into the flat plate-shaped connecting portion by compacting, and a joining step of electrically joining the connecting portion to the plate-shaped section of the terminal member by welding, with a plate surface of the connecting portion disposed in surface contact with the plate-shaped section.

According to the present embodiment, in the conductor forming step, the inner conductor of the coaxial cable is processed into a flat plate-shaped connecting portion by compacting, and, in the joining step, the connecting portion is welded to the plate-shaped section of the terminal member in surface contact therewith. The contact area between the connecting portion of the coaxial cable and the plate-shaped section of the terminal member thereby increases, thus enabling the welding area between the connecting portion and the plate-shaped section to be increased, and contact resistance between the connecting portion and the plate-shaped section to be reduced.

### BRIEF DESCRIPTION OF DRAWINGS

FIG. 1A is a plan view showing the configuration of a plug and a socket according to the present embodiment.

FIG. 1B is a front view showing the configuration of the plug and the socket.

FIG. 2 is a longitudinal sectional view of FIG. 1B and a partially enlarged view thereof.

FIG. 3 is a longitudinal sectional view of a state in which the plug is mated with the socket.

FIG. 4 is a partially enlarged cross-sectional view taken along line IV-IV of the plug in FIG. 1A.

FIG. 5 is an exploded perspective view of the plug.

FIG. 6 is an exploded perspective view of the plug.

FIG. 7 is a schematic explanatory diagram of compacting.

FIG. 8 is a schematic explanatory diagram of series welding.

FIG. 9 is a longitudinal sectional view showing series welding being performed.

### DESCRIPTION OF EMBODIMENTS

Hereinafter, embodiments of a plug and a method for manufacturing the plug according to the present disclosure will be described in detail with reference to the drawings. Note that the embodiments described below are illustrative examples for describing a plug and a method for manufacturing the plug, and the plug and the method for manufacturing the plug are not limited to only these embodiments. Accordingly, the plug and the method for manufacturing the plug according to the present disclosure can be implemented in various modes that do not deviate from the spirit thereof.

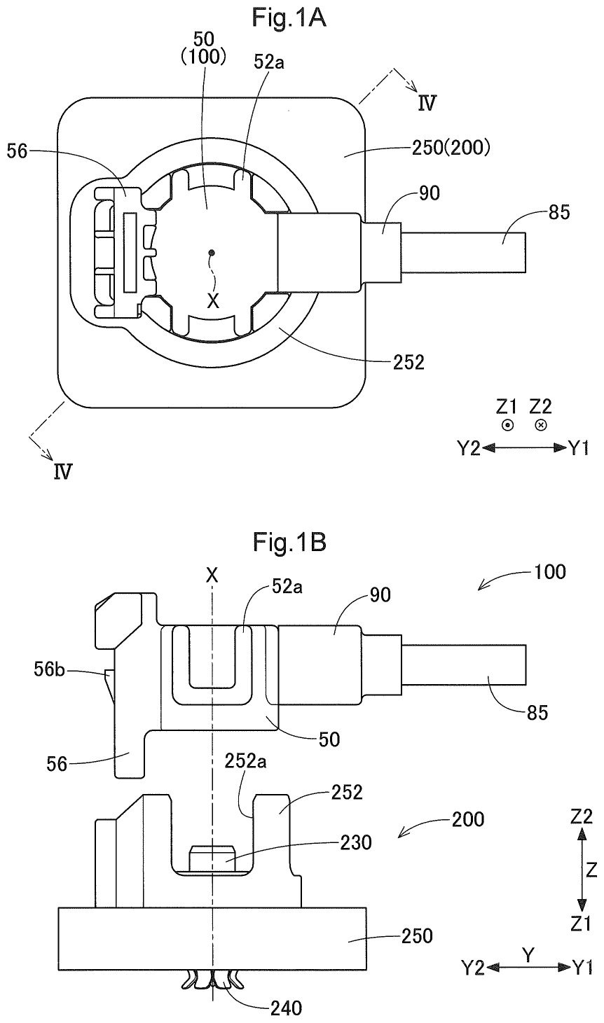

As shown in FIGS. 1A and 1B, electrically connected to a plug 100 according to the present embodiment is a coaxial cable 85. The plug 100 is electrically connectable to a socket 200 for mating with the plug 100.

### Configuration of Plug

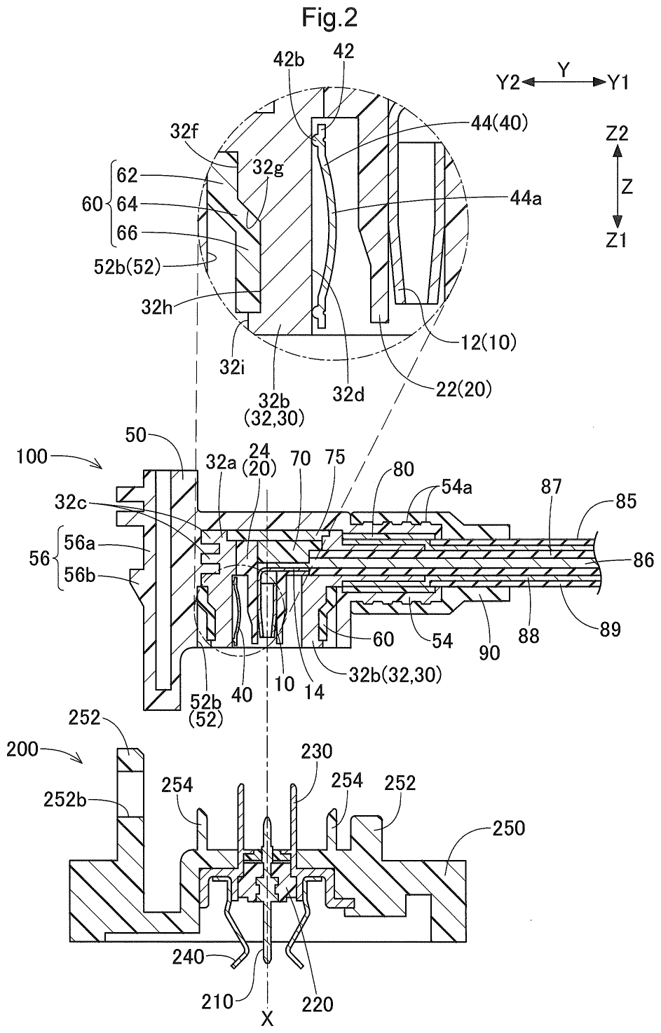

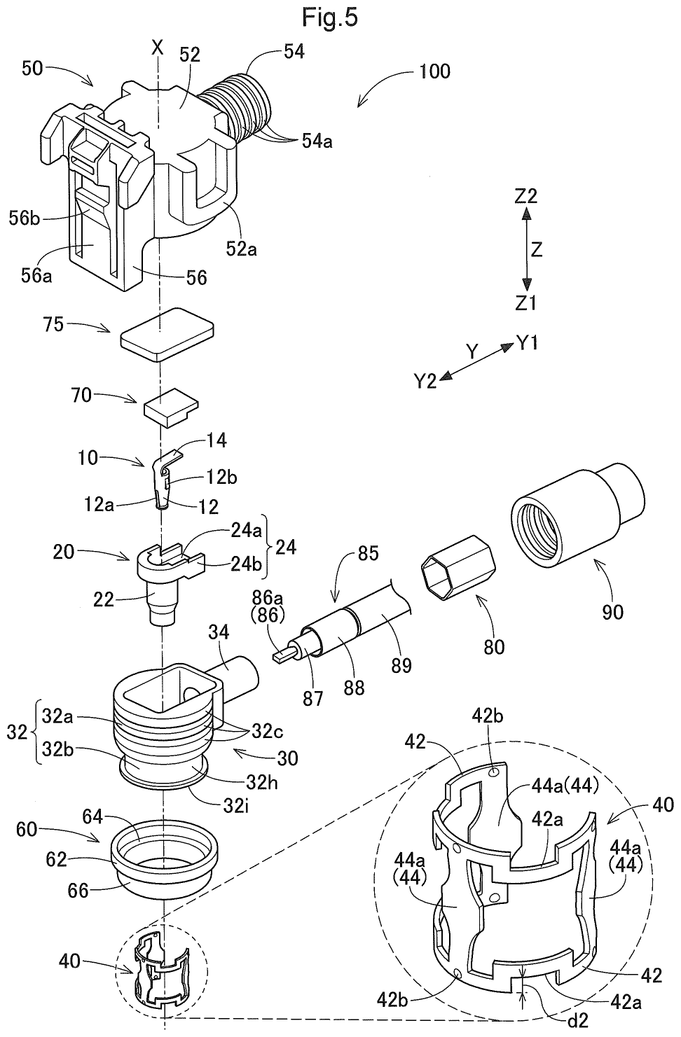

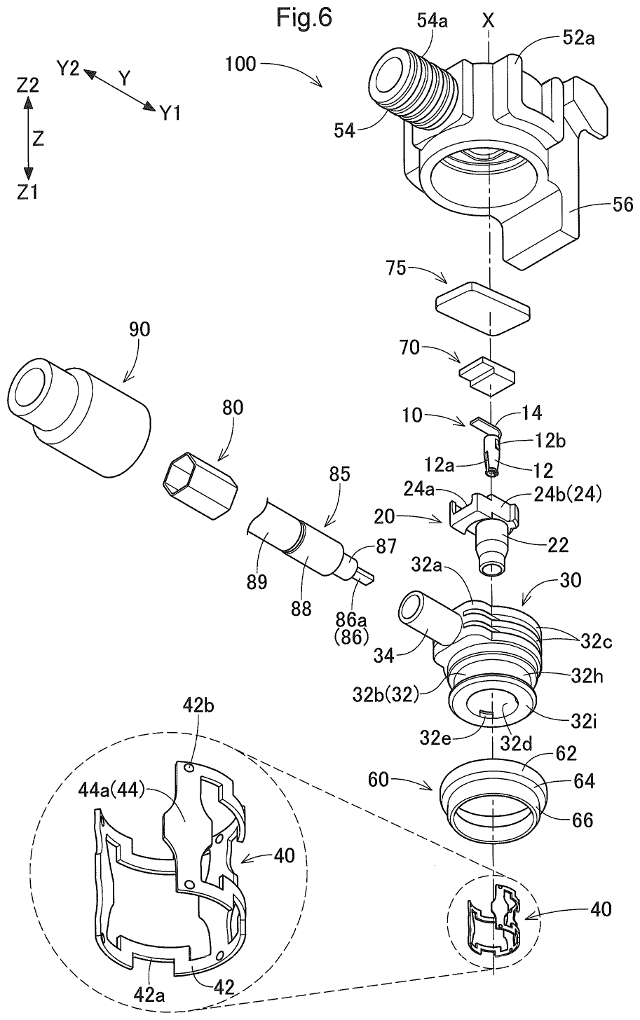

The configuration of the plug 100 according to the present embodiment will be described with reference to FIGS. 2 to 6. As shown in FIGS. 5 and 6, the plug 100 includes a first contact 10 (example of terminal member), a first holder 20 (example of holder), a first shell 30 (example of shell), a first grounding member 40 (example of grounding member), a first housing 50 (example of housing), a packing 60, a holder cover 70, a shell cover 75, a ferrule 80, the coaxial cable 85, and a cable cover 90.

### First Contact

As shown in FIGS. 5 and 6, the first contact 10 is made of a metal having conductivity and elasticity such as a copper alloy, and is formed in an L-shape as a whole. The first contact 10 includes a connecting section 12 and a plate-shaped section 14. The connecting section 12 has a substantially cylindrical shape. Hereinafter, the central axis of the connecting section 12 will be referred to as axis X. Also, the direction parallel to the axis X will be referred to as the “Z direction”, the direction in which and side on which the connecting section 12 is disposed relative to the plate-shaped section 14 and parallel to the Z direction will be referred to as the “Z1 direction” and “Z1 side”, and the opposite direction and side will be referred to as the “Z2 direction” and “Z2 side”. The Z direction is a general term for the Z1 direction and the Z2 direction. Furthermore, the direction parallel to the extension direction of the plate-shaped section 14 among the directions orthogonal to the Z direction will be referred to as the “Y direction”. In the Y direction, the direction and side toward the extension end of the plate-shaped section 14 from the connecting section 12 will be referred to as the “Y1 direction” and “Y1 side”, and the opposite direction and side will be referred to as the “Y2 direction” and “Y2 side”.

The connecting section 12 has slits 12a formed in the Z2 direction from the Z1 side end thereof to approximately half of the length of the connecting section 12 in the Z direction. Two slits 12a in total are formed at positions that are point symmetric to the axis X, and the slits 12a are formed on a plane that passes through the axis X in parallel to the Y direction and the Z direction. The portion of the connecting section 12 in which the slits 12a are formed decreases in diameter in the Z1 direction. The Z1 side end of this portion that decreases in diameter increases in diameter due to elastic deformation when a later-described second contact 210 of the socket 200 is inserted and is electrically connected to the second contact 210.

In a portion located on the Z2 side of the connecting section 12 where the slits 12a are not formed, two cutouts 12b cut out and raised toward the Z1 side are formed. The cutouts 12b are shifted by 90 degrees in the circumferential direction of the connecting section 12 relative to the slits 12a.

The plate-shaped section 14 extends from the Z2 side end of the connecting section 12. The plate-shaped section 14 extends in the Z2 direction from the Z2 side end of the connecting section 12 and is then bent 90 degrees and extends in the Y1 direction. The plate surface of the plate-shaped section 14 is orthogonal to the axis X.

### First Holder

The first holder 20 accommodates the first contact 10 internally and is made of an insulator such as a resin. The first holder 20 is formed by injection molding. As shown in FIGS. 5 and 6, the first holder 20 has a cylindrical section 22 and a contact mounting section 24 disposed at the Z2 side end of the cylindrical section 22. The inner diameter of the inner peripheral surface of the cylindrical section 22 is equal to the outer diameter of the portion (portion where slits 12a are not formed) on the Z2 side of the connecting section 12 of the first contact 10 (see FIG. 2). The axis of the cylindrical section 22 is coaxial with the axis X when the first contact 10 is accommodated therein. The cylindrical section 22 has, on the inner peripheral surface thereof, two locking grooves (not shown) in which the cutouts 12b of the first contact 10 are fitted and locked. The first contact 10 accommodated in the first holder 20 is thereby restricted from moving in the Z1 direction relative to the first holder 20, moving in directions perpendicular to the Z direction including the Y direction, and rotating relative to the first holder 20.

The contact mounting section 24 is integrally formed with the cylindrical section 22, and has a plate-shaped mounting section 24a orthogonal to the axis X and a wall 24b formed in the Z direction around the mounting section 24a. The wall 24b is, however, not present on the Y1 side. Also, the space in the Z2 direction relative to the contact mounting section 24 is open to the outside. A hole connecting to the inner space of the cylindrical section 22 is open in the mounting section 24a of the contact mounting section 24, and the first contact 10 is inserted in the Z1 direction through this hole. When the cutouts 12b of the first contact 10 are locked by the locking grooves of the first holder 20, the plate-shaped section 14 of the first contact 10 comes in contact with the mounting section 24a of the contact mounting section 24.

The plate-shaped holder cover 70 is attached to the contact mounting section 24 of the first holder 20. The holder cover 70 is fixed to the contact mounting section 24 by a method such as press-fitting or bonding. The space open in the Z2 direction relative to the contact mounting section 24 is closed by attaching the holder cover 70, and the first contact 10 is not visible when viewed in the Z1 direction from the Z2 side (hereinafter also referred to as plan view). With the holder cover 70 attached to the contact mounting section 24, the surface of the holder cover 70 on the Z2 side is flush with the contact mounting section 24 of the first holder 20.

As will be described later, the holder cover 70 is attached to the contact mounting section 24 after electrically connecting an inner conductor 86 (connecting portion 86a) and an outer conductor 88 of the coaxial cable 85 to the first contact 10 and the first shell 30, respectively. Attaching the holder cover 70 restricts movement of the first contact 10 in the Z2 direction. This results in the first contact 10 being immovably fixed with respect to the first holder 20 (see FIG. 2).

### First Shell

The first shell 30 accommodates the first holder 20 internally and is made of a conductive metal such as iron. As shown in FIGS. 5 and 6, the first shell 30 has a tubular accommodating section 32 in which the first holder 20 is accommodated internally, and a cylindrical cable holding section 34 extending in the Y1 direction from the side surface of the accommodating section 32. The first holder 20 is accommodated in the Z1 direction from the Z2 side of the first shell 30. The inner space of the accommodating section 32 communicates with the inner space of the cable holding section 34. The first shell 30 is provided to ensure shielding of the first contact 10. The first shell 30 is at ground potential when the plug 100 is in use.

The contact mounting section 24 of the first holder 20 is disposed in the inner space of a first accommodating section 32a disposed on the Z2 side of the accommodating section 32. The inner space of the first accommodating section 32a has a shape in which the contact mounting section 24 of the first holder 20 fits tightly, in such a manner that the accommodated first holder 20 can be positioned. Specifically, the first accommodating section 32a has a square tubular shape. The first holder 20 is thereby restricted from moving in directions perpendicular to the Z direction including the Y direction. On the side surface of the first accommodating section 32a are formed a plurality of (three in the present embodiment) flanges 32c whose outward facing outer shape is circular. The three flanges 32c are spaced from each other in the Z direction.

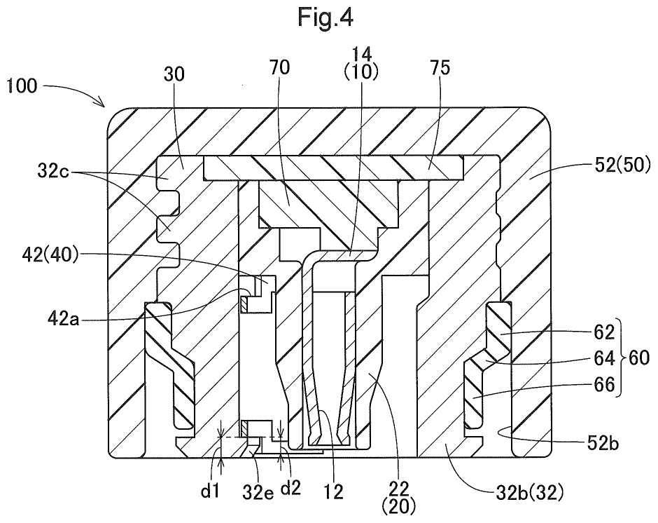

As shown in FIG. 2, the connecting section 12 of the first contact 10 and the cylindrical section 22 of the first holder 20 are disposed in the inner space of a second accommodating section 32b disposed on the Z1 side of the accommodating section 32. The second accommodating section 32b has a cylindrical shape, and a first inner peripheral surface 32d (example of cylindrical inner surface) of the second accommodating section 32b is spaced radially from the cylindrical section 22 of the first holder 20. The axis of the second accommodating section 32b is coaxial with the axis X when the first contact 10 and the first holder 20 are accommodated therein. At the end of the first inner peripheral surface 32d on the Z1 side of the second accommodating section 32b are formed a plurality of (two in the present embodiment) protrusions 32e that protrude radially inward (see FIGS. 4 and 6). As shown in FIG. 4, the protrusions 32e have a shape that protrudes more radially inward preceding in the Z2 direction from the Z1 side end thereof. The two protrusions 32e are spaced from each other such that the central angle of the axis X therebetween is 120 degrees. The length of the protrusions 32e in the Z direction is d1.

The area of the cross-section of the inner space of the first accommodating section 32a perpendicular to the axis X is larger than the area of the cross-section of the inner space of the second accommodating section 32b perpendicular to the axis X. This results in a step between the inner peripheral surface that divides the inner space of the first accommodating section 32a and the first inner peripheral surface 32d that divides the inner space of the second accommodating section 32b. The contact mounting section 24 of the first holder 20 is mounted in this step, and movement of the first holder 20 in the Z1 direction is thereby restricted.

The plate-shaped shell cover 75 is attached to the Z2 side end of the accommodating section 32 (first accommodating section 32a). The shell cover 75 is fixed to the first accommodating section 32a by a method such as press-fitting, crimping, or bonding. When attached to the first accommodating section 32a, the shell cover 75 comes in contact with the contact mounting section 24 of the first holder 20 and the holder cover 70. Movement of the first holder 20 in the Z2 direction is thereby restricted. This results in the first holder 20 being immovably fixed with respect to the first shell 30. Also, the gap between the first accommodating section 32a and the shell cover 75 is thereby sealed.

### First Grounding Member

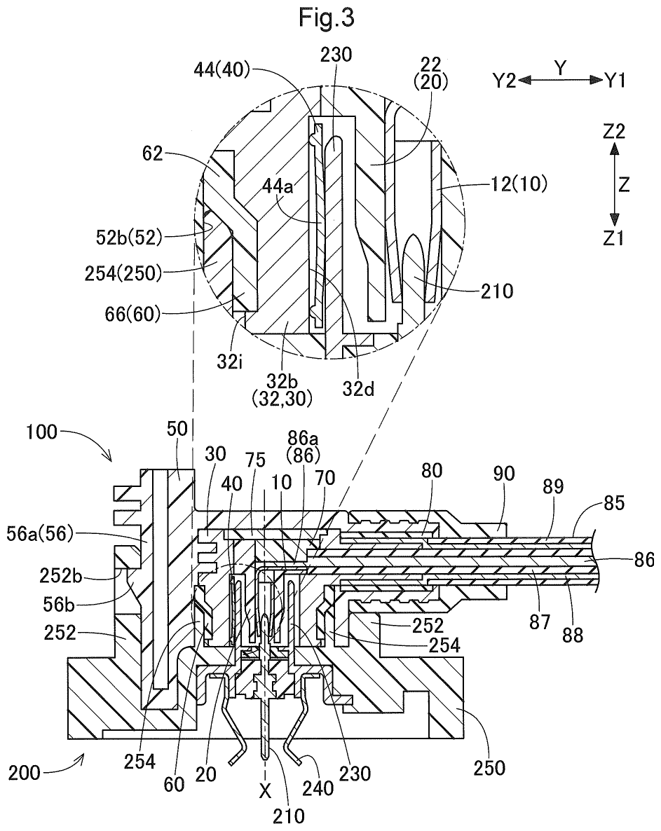

As shown in FIGS. 5 and 6, the first grounding member 40 includes a pair of supports 42 and a first ground contact 44. The pair of supports 42 is integrally formed with the first ground contact 44. The first grounding member 40 is made of a metal having conductivity and elasticity such as a copper alloy. The two supports 42 are disposed at a distance from each other, and a plurality of (three in the present embodiment) first ground contacts 44 are disposed so as to connect the pair of supports 42. The first grounding member 40 is provided to establish an electrical connection between the first shell 30 and a later-described second shell 230 of the socket 200 (see FIG. 3).

The supports 42 have a circular arc shape whose central angle is 240 degrees in plan view. The inner diameter of the supports 42 is the same as or slightly larger than the inner diameter of the first inner peripheral surface 32d of the second accommodating section 32b of the first shell 30. The supports 42 each have a plurality of (two in the present embodiment) recesses 42a. In each recess 42a, a portion thereof extending in the circumferential direction of one of the supports 42 is depressed in a U-shape toward the other support 42 (along the axis X). The recesses 42a are formed at locations where the central angles from one end of the circular arc-shaped supports 42 in the circumferential direction are 60 degrees and 180 degrees in plan view. The two recesses 42a of one of the supports 42 respectively oppose the two recesses 42a of the other support 42. The length of the depressions of the recesses 42a in the Z direction is d2. The depression length d2 is shorter than the length d1 of the protrusion 32e in the Z direction (see FIG. 4).

The first ground contacts 44 are formed at central angles of 0 degrees, 120 degrees, and 240 degrees in plan view from one end of the circular arc-shaped supports 42 in the circumferential direction. That is, the first ground contacts 44 are formed at both ends and in the center of the supports 42 in the circumferential direction, and are formed at different locations from where the recesses 42a are formed. As shown in FIG. 2, the first ground contacts 44 have an arc shape that flexes radially inward, and the center thereof in the Z direction is a first contact section 44a whose width (circumferential length) is larger than both ends thereof (see FIG. 5). The first contact section 44a is where the first ground contacts 44 protrude most radially inward.

At each of the locations (six locations in the present embodiment) where the pair of supports 42 are connected to the first ground contacts 44 is formed a second contact section 42b that protrudes radially outward. In this way, the first grounding member 40 has a vertically symmetrical shape.

The first grounding member 40 is accommodated in the second accommodating section 32b from the Z1 side of the accommodating section 32 of the first shell 30 in a reduced diameter state, and thereafter, the supports 42 increase in diameter radially outward due to elastic force, and the six second contact sections 42b are pressed against the first inner peripheral surface 32d (see FIG. 2). The first grounding member 40 is thereby electrically connected to the first shell 30. At this time, as shown in FIG. 4, the two protrusions 32e of the first inner peripheral surface 32d respectively fit into the two recesses 42a of the support 42 on the Z1 side, and the support 42 on the Z2 side approaches the step between the first accommodating section 32a and the second accommodating section 32b. The first grounding member 40 is thereby restricted from moving in the Z direction relative to the first inner peripheral surface 32d and rotating relative to the first shell 30. Also, as described above, the length d1 of the protrusions 32e in the Z direction is longer than the depression length d2 of the recesses 42a in the Z direction. Accordingly, with the first grounding member 40 accommodated in the second accommodating section 32b of the first shell 30, the support 42 on the Z1 side of the first grounding member 40 is located at the Z1 side end of the second accommodating section 32b of the first shell 30, but does not protrude from the second accommodating section 32b.

As shown in FIGS. 5 and 6, the two recesses 42a of one of the supports 42 respectively oppose the two recesses 42a of the other support 42, and thus the distance between the opposing recesses 42a is shorter than the distance between opposing portions of the supports 42 other than the recesses 42a. Also, as described above, the first ground contacts 44 bridge across at different locations from where the recesses 42a of the pair of supports 42 are formed. Furthermore, the support 42 on the Z1 side is disposed at the Z1 side end of the second accommodating section 32b. Thus, the contact length of the first ground contacts 44 can be increased, compared to the case where the first ground contacts 44 are formed between the recesses 42a and to the contacts of the plug disclosed in JP 59-65489UM-A. Stress that occurs at both ends of the first ground contacts 44 (boundary with supports 42) during elastic deformation of the first ground contacts 44 thereby decreases and the limit of elasticity increases, thus enabling a plug 100 capable of ensuring stable contact performance over of long period of time to be realized.

### Fixing of Coaxial Cable

Next, as part of the method for manufacturing the plug 100, a method for connecting the coaxial cable 85 to the first contact 10 will be described. As shown in FIGS. 5 and 6, the coaxial cable 85 includes the inner conductor 86 having a circular cross-section which is the center wire, an insulating dielectric 87 disposed around the inner conductor 86, the outer conductor 88 disposed around the dielectric 87, and an insulating protective coating 89 disposed around the outer conductor 88. In the coaxial cable 85, the inner conductor 86 is electrically connected to the first contact 10, and the outer conductor 88 is electrically connected to the first shell 30 (see FIG. 2). The coaxial cable 85 extends in a direction (Y1 direction) perpendicular to the axis X. In other words, the plug 100 has an L shape in which the insertion direction (Z direction) of the first contact 10 into the socket 200 is orthogonal to the extension direction (Y direction) of the coaxial cable 85.

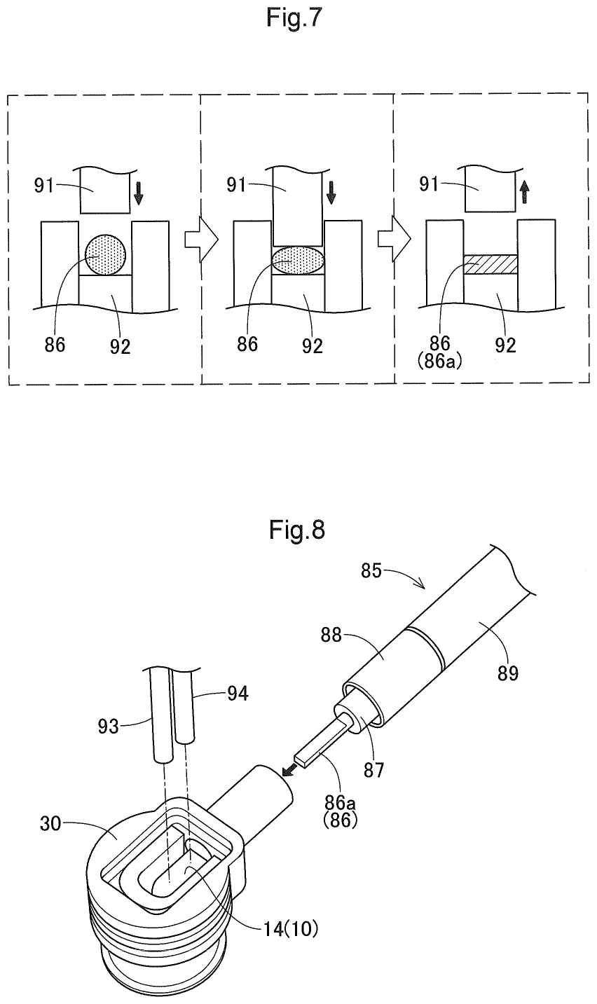

The inner conductor 86 of the coaxial cable 85 used in the present embodiment is a stranded wire and is formed into a flat plate shape by compacting shown in FIG. 7 (conductor forming step). Hereinafter, the flat plate-shaped portion of the inner conductor 86 formed by compacting will be referred to as connecting portion 86a. While a detailed description will be omitted since compacting is a known construction method, the method involves the inner conductor 86 having a circular cross-section being sandwiched between a first electrode 91 and a second electrode 92, and current being applied to melt the inner conductor 86 under pressure and form a flat plate shape.

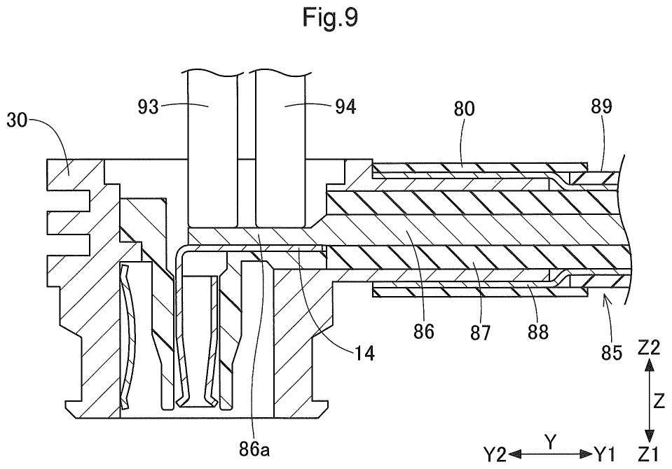

Also, as shown in FIGS. 8 and 9, the connecting portion 86a and the dielectric 87 are inserted into the space on the inner side of the cable holding section 34 of the first shell 30, and the plate surface of the connecting portion 86a opposes the plate surface of the plate-shaped section 14 of the first contact 10 in surface contact therewith. At this time, the holder cover 70 and the shell cover 75 are not attached, and the plate-shaped section 14 of the first contact 10 and the connecting portion 86a are visibly exposed in plan view. In this state, the connecting portion 86a of the inner conductor 86 and the plate-shaped section 14 are melted and welded together by supplying current to the boundary between the connecting portion 86a and the plate-shaped section 14 with a third electrode 93 and a fourth electrode 94 pressed against the connecting portion 86a from the Z2 side of the first shell 30 (series welding). The connecting portion 86a is thereby electrically connected to the plate-shaped section 14 (joining step). In this way, the contact area becomes larger when the plate-shaped section 14 of the first contact 10 and the connecting portion 86a of the coaxial cable 85 are brought in surface contact with each other, and thus the welding area between the plate-shaped section 14 and the connecting portion 86a increases, and contact resistance between the plate-shaped section 14 and the connecting portion 86a can be reduced. Thereafter, the holder cover 70 and the shell cover 75 are attached.

The outer conductor 88 closely contacts the outer peripheral surface of the cable holding section 34 of the first shell 30. At this time, the cylindrical ferrule 80 is passed onto the coaxial cable 85 in advance. By crimping with the ferrule 80 overlapping the outer conductor 88 and the cable holding section 34, the outer conductor 88 is electrically connected to the cable holding section 34.

### First Housing

As shown in FIGS. 5 and 6, the first housing 50 is made of an insulating resin, and is formed by insert molding, with the first contact 10, the first holder 20, the first shell 30, the first grounding member 40, the holder cover 70, the shell cover 75, the coaxial cable 85, and the ferrule 80 assembled together integrally. The first housing 50 has a first portion 52 externally fitted to the first shell 30, a second portion 54 externally fitted to the ferrule 80, and a third portion 56 disposed on the Y2 side of the first portion 52.

The first portion 52 closely contacts the first accommodating section 32a of the first shell 30. Thus, as shown in FIG. 2, the first portion 52 enters between the three flanges 32c formed at intervals on the side surface of the first accommodating section 32a, and immovably fixes the first shell 30 with respect to the first housing 50 in close contact with the first shell 30. The portion of the first portion 52 that opposes the second accommodating section 32b of the first shell 30 has a cylindrical shape externally fitted to the second accommodating section 32b and is spaced from the second accommodating section 32b.

As shown in FIGS. 5 and 6, on the outer peripheral surface of the first portion 52 are formed a pair of U-shaped positioning protrusions 52a in a direction perpendicular to the Z direction and the Y direction. The positioning protrusions 52a are positioned when mating the plug 100 with the socket 200. The width of the positioning protrusions 52a (length parallel to Y direction) is the same as or larger than the outer diameter of the later-described cable cover 90 when attached to the ferrule 80.

The second portion 54 extends from the ferrule 80 to the protective coating 89 of the coaxial cable 85. On the outer peripheral surface of the second portion 54 are formed a plurality of annular protrusions 54a (four in the present embodiment).

The third portion 56 has a bottomed square tubular shape as a whole, and this shape is positioned when the plug 100 is mated with the socket 200. In the wall on the Y2 side of the third portion 56 is formed a beam 56a that extends in the Z direction by slits being formed on both sides thereof. In a central section of the beam 56a is formed a claw 56b. The third portion 56 is disposed at a position rotated 180 degrees from the coaxial cable 85 with respect to the axis X.

### Packing

As shown in FIG. 2, the packing 60 is disposed between the outer peripheral surface of the second accommodating section 32b of the accommodating section 32 of the first shell 30 and a second inner peripheral surface 52b of the first portion 52 of the first housing 50. The packing 60 is made of a member having elasticity such as rubber, and has an annular shape with a uniform thickness (radial length) as a whole.

On the outer peripheral surface of the second accommodating section 32b of the first shell 30 are disposed a large diameter surface 32f, a tapered surface 32g, a small diameter surface 32h, and a flange section 32i in the stated order in the Z1 direction from the Z2 side. The flange section 32i protrudes radially outward with respect to the small diameter surface 32h and has an annular shape. The second inner peripheral surface 52b of the first portion 52 of the first housing 50 has the same inner diameter throughout its entirety. Thus, the radial gap between the tapered surface 32g and the second inner peripheral surface 52b widens relative to the constant radial gap between the large diameter surface 32f and the second inner peripheral surface 52b, the radial gap between the small diameter surface 32h and the second inner peripheral surface 52b is constant in the widened state, and the radial gap between the outer peripheral surface of the flange section 32i and the second inner peripheral surface 52b is narrow compared to the small diameter surface 32h.

The annular packing 60 includes a large diameter section 62, a tapered section 64, and a small diameter section 66. The large diameter section 62 has a radial thickness that fits tightly into the radial gap between the large diameter surface 32f of the second accommodating section 32b of the first shell 30 and the second inner peripheral surface 52b of the first portion 52 of the first housing 50. The inner peripheral surface of the tapered section 64 and the inner peripheral surface of the small diameter section 66 respectively come in contact with the tapered surface 32g and the small diameter surface 32h of the second accommodating section 32b. The tapered section 64 and the small diameter section 66 are spaced from the second inner peripheral surface 52b of the first portion 52 of the first housing 50. The Z1 side end of the small diameter section 66 is located further in the Z2 direction than the flange section 32i of the second accommodating section 32b, and the flange section 32i protrudes radially outward by less than the thickness of the small diameter section 66. The flange section 32i prevents the packing 60 from coming off the first shell 30.

### Cable Cover

The cable cover 90 is so-called heat shrink tubing, and, as shown in FIG. 2, covers from the second portion 54 of the first housing 50 to the protective coating 89 of the coaxial cable 85. The cable cover 90 closely contacts the uneven surface of the second portion 54 that includes the protrusions 54a, thereby preventing the cable cover 90 from moving or coming off. By covering the ferrule 80 and the coaxial cable 85 with the cable cover 90, dust, water droplets, and the like are prevented from intruding into the first contact 10 and the first shell 30 via the surface of the coaxial cable 85.

### Structure of Socket

As shown in FIG. 2, the socket 200 includes the second contact 210, a second holder 220, the second shell 230, a second grounding member 240, and a second housing 250. The socket 200 is for mating with the plug 100.

The second contact 210 has a rod shape made of a conductive metal or the like, and is disposed along the axis X. The second contact 210 is electrically connected to the connecting section 12 of the first contact 10 of the plug 100, by the plug 100 mating with the socket 200.

The second holder 220 made of resin is integrally formed with the second contact 210 by insert molding and disposed on an outer peripheral surface of the second contact 210 in approximately the middle thereof in the direction of the axis X. The second holder 220 has a cylindrical shape through the center of which the second contact 210 passes.

The second shell 230 is made of a conductive metal. The second shell 230 covers the outer side of the second holder 220 and has a tubular shape. The second shell 230 is electrically connected to the first shell 30, via contact with the first grounding member 40 of the plug 100, through mating of the plug 100 with the socket 200. The second shell 230 is provided to ensure shielding of the second contact 210. The second shell 230 is at ground potential when the socket 200 is in use.

The second grounding member 240 is made of a conductive metal having elasticity and is electrically connected to the second shell 230. The second grounding member 240 is disposed annularly in a plurality of (eight in the present embodiment) locations. The second grounding members 240 are also provided to ensure shielding of the second contact 210.

The second housing 250 is made of an insulating resin and accommodates the second contact 210, the second holder 220, the second shell 230, and the second grounding member 240. The second housing 250 includes an outer peripheral wall 252 that is annular in plan view and accommodates the first housing 50 of the plug 100, when the plug 100 is mated with the socket 200 (see FIGS. 1A and 1B). The outer peripheral wall 252 has insertion recesses 252a into which the positioning protrusions 52a of the first housing 50 of the plug 100 and the coaxial cable 85 fit. In other words, the outer peripheral wall 252 has three insertion recesses 252a, and the central angles between adjacent insertion recesses 252a with respect to the axis X are all 90 degrees. Also, as shown in FIG. 2, the inner side of the outer peripheral wall 252 has an engagement hole 252b into which the third portion 56 of the first housing 50 enters and with which the claw 56b engages. Furthermore, on the inner peripheral side of the outer peripheral wall 252 is formed a cylindrical sealing wall 254 at a distance from the outer peripheral wall 252.

### Mating Between Plug and Socket

When the plug 100 is mated with the socket 200, the first housing 50 of the plug 100 is accommodated inside the outer perimeter wall 252 of the second housing 250 of the socket 200, as shown in FIG. 3. At this time, the sealing wall 254 comes in contact with the outer peripheral surface of the small diameter section 66 of the packing 60 and seals the gap between the plug 100 and the socket 200. Intrusion of dust, water droplets, and the like through the contact points between the first contact 10 of the plug 100 and the second contact 210 of the socket 200 and the contact points between the first shell 30 and the first grounding member 40 of the plug 100 and the second shell 230 of the socket 200 is thereby prevented.

Also, by the claw 56b of the first housing 50 of the plug 100 locking in the engagement hole 252b of the outer peripheral wall 252 of the socket 200 at this time, the plug 100 and the socket 200 will not become disengaged from each other, even if external vibration or shock is applied to the plug 100 and the socket 200.

By mating the plug 100 with the socket 200, the inner conductor 86 of the coaxial cable 85 of the plug 100 is electrically connected to the second contact 210 of the socket 200 via the first contact 10. Also, the outer conductor 88 is electrically connected to the second grounding member 240 via the first shell 30, the first grounding member 40, and the second shell 230. The second contact 210 and the second grounding member 240 of the socket 200 are electrically connected to a connector not shown. The second accommodating section 32b of the first shell 30 of the plug 100 and the second shell 230 of the socket 200 both have a cylindrical shape, and thus shielding will not be adversely affected at the contact points between the first shell 30 and the second shell 230, even if the first grounding member 40 has a circular arc shape in plan view rather than a cylindrical shape.

### Other Embodiments

(1) In the above embodiment, the inner conductor 86 of the coaxial cable 85 is formed into the flat plate-shaped connecting portion 86a by compacting and then welded to the plate-shaped section 14 of the first contact 10, but the present disclosure is not limited thereto. The inner conductor 86 having a circular cross-section may be welded directly to the plate-shaped section 14 without being compacted. Also, the inner conductor 86 of the coaxial cable 85 may be a single wire rather than a stranded wire.

(2) In the above embodiment, the electrical connection between the outer conductor 88 of the coaxial cable 85 and the cable holding section 34 of the first shell 30 is conducted by crimping the ferrule 80, but the present disclosure is not limited thereto. Instead of the ferrule 80, the electrical connection between the outer conductor 88 and the cable holding section 34 may be established by a conductive bonding agent, for example, and the means thereof are not limited.

(3) In the above embodiment, the cable cover 90 is constituted by heat shrink tubing, but the present disclosure is not limited thereto. The cable cover 90 may be formed by insert molding, for example. Also, the cable cover 90 need not necessarily be provided, as long as there is no intrusion of dust, water droplets, or the like into the first contact 10 or the first shell 30 via the surface of the coaxial cable 85.

(4) In the above embodiment, the coaxial cable 85 is disposed at a position rotated 180 degrees from where the third portion 56 of the first housing 50 is disposed with respect to the axis X, but the present disclosure is not limited thereto. The coaxial cable 85 may be interchanged with one of the two positioning protrusions 52a of the first housing 50 of the above embodiment. By adopting such a configuration, a plug 100 can be obtained in which the coaxial cable 85 is disposed at a position rotated 90 degrees in the clockwise or counterclockwise direction in plan view from where the third portion 56 of the first housing 50 is disposed with respect to the axis X. In this case, in the plug 100, only the shape of the first housing 50 need be changed, and the other constituent components can be used without modification. The socket 200 has three insertion recesses 252a and can thus be used without any modification.

1. A plug electrically connected to a coaxial cable, comprising:
a conductive terminal member having a cylindrical connecting section electrically connected to an inner conductor of the coaxial cable;
an insulating holder externally fitted to the terminal member in such a manner as to be coaxial with an axis of the connecting section of the terminal member;
a conductive shell electrically connected to an outer conductor of the coaxial cable and externally fitted to the holder in such a manner as to be coaxial with the axis; and
a conductive grounding member disposed between the shell and the holder,
the shell including
a cylindrical inner surface on which the connecting section and the holder are disposed on an inner side coaxially with the axis; and
a protrusion protruding radially inward from part of the cylindrical inner surface,
the grounding member including
a pair of circular arc-shaped supports electrically connected to the shell by coming in contact with the cylindrical inner surface; and
an elastically deformable contact supported by the pair of supports,
at least one of the two supports including a recess formed in a different place from where the contact is disposed, and
the grounding member being fixed to the shell by the protrusion fitting into the recess.

2. The plug according to claim 1,
wherein the protrusion is formed at an end into which a socket for mating with the plug is fitted, and
the protrusion is longer than the recess in a direction along the axis.

3. The plug according to claim 1, further comprising:
a housing externally fitted to the shell; and
an annular packing disposed between the shell and the housing,
wherein the packing includes
a large diameter section that comes in contact with both the shell and the housing, and
a small diameter section that comes in contact with only the shell and has a gap to the housing, and
the socket for mating with the plug is fitted in such a manner as to come in contact with the small diameter section in the gap.

4. The plug according to claim 2, further comprising:
a housing externally fitted to the shell; and
an annular packing disposed between the shell and the housing,
wherein the packing includes
a large diameter section that comes in contact with both the shell and the housing, and
a small diameter section that comes in contact with only the shell and has a gap to the housing, and
the socket for mating with the plug is fitted in such a manner as to come in contact with the small diameter section in the gap.

5. The plug according to claim 3,
wherein the shell has a flange section that prevents the packing from coming off.

6. The plug according to claim 4,
wherein the shell has a flange section that prevents the packing from coming off.

7. The plug according to claim 1,
wherein the terminal member has a plate-shaped section integrally formed with the connecting section,
the inner conductor of the coaxial cable includes a flat plate-shaped connecting portion to be electrically connected to the plate-shaped section, and
the plate-shaped section is electrically connected to the connecting portion in surface contact therewith.

8. The plug according to claim 2,
wherein the terminal member has a plate-shaped section integrally formed with the connecting section,
the inner conductor of the coaxial cable includes a flat plate-shaped connecting portion to be electrically connected to the plate-shaped section, and
the plate-shaped section is electrically connected to the connecting portion in surface contact therewith.

9. The plug according to claim 3,
wherein the terminal member has a plate-shaped section integrally formed with the connecting section,
the inner conductor of the coaxial cable includes a flat plate-shaped connecting portion to be electrically connected to the plate-shaped section, and
the plate-shaped section is electrically connected to the connecting portion in surface contact therewith.

10. The plug according to claim 4,
wherein the terminal member has a plate-shaped section integrally formed with the connecting section,
the inner conductor of the coaxial cable includes a flat plate-shaped connecting portion to be electrically connected to the plate-shaped section, and
the plate-shaped section is electrically connected to the connecting portion in surface contact therewith.

11. The plug according to claim 5,
wherein the terminal member has a plate-shaped section integrally formed with the connecting section,
the inner conductor of the coaxial cable includes a flat plate-shaped connecting portion to be electrically connected to the plate-shaped section, and
the plate-shaped section is electrically connected to the connecting portion in surface contact therewith.

12. The plug according to claim 6,
wherein the terminal member has a plate-shaped section integrally formed with the connecting section,
the inner conductor of the coaxial cable includes a flat plate-shaped connecting portion to be electrically connected to the plate-shaped section, and
the plate-shaped section is electrically connected to the connecting portion in surface contact therewith.

13. A method for manufacturing the plug according to claim 7, comprising:
a conductor forming step of forming the inner conductor of the coaxial cable into the flat plate-shaped connecting portion by compacting; and
a joining step of electrically joining the connecting portion to the plate-shaped section of the terminal member by welding, with a plate surface of the connecting portion disposed in surface contact with the plate-shaped section.

14. A method for manufacturing the plug according to claim 8, comprising:
a conductor forming step of forming the inner conductor of the coaxial cable into the flat plate-shaped connecting portion by compacting; and
a joining step of electrically joining the connecting portion to the plate-shaped section of the terminal member by welding, with a plate surface of the connecting portion disposed in surface contact with the plate-shaped section.

15. A method for manufacturing the plug according to claim 9, comprising:
a conductor forming step of forming the inner conductor of the coaxial cable into the flat plate-shaped connecting portion by compacting; and
a joining step of electrically joining the connecting portion to the plate-shaped section of the terminal member by welding, with a plate surface of the connecting portion disposed in surface contact with the plate-shaped section.

16. A method for manufacturing the plug according to claim 10, comprising:
a conductor forming step of forming the inner conductor of the coaxial cable into the flat plate-shaped connecting portion by compacting; and
a joining step of electrically joining the connecting portion to the plate-shaped section of the terminal member by welding, with a plate surface of the connecting portion disposed in surface contact with the plate-shaped section.

17. A method for manufacturing the plug according to claim 11, comprising:
a conductor forming step of forming the inner conductor of the coaxial cable into the flat plate-shaped connecting portion by compacting; and
a joining step of electrically joining the connecting portion to the plate-shaped section of the terminal member by welding, with a plate surface of the connecting portion disposed in surface contact with the plate-shaped section.

18. A method for manufacturing the plug according to claim 12, comprising:
a conductor forming step of forming the inner conductor of the coaxial cable into the flat plate-shaped connecting portion by compacting; and
a joining step of electrically joining the connecting portion to the plate-shaped section of the terminal member by welding, with a plate surface of the connecting portion disposed in surface contact with the plate-shaped section.
